(19) United States
(12) Patent Application Publication
(10) Pub. No.: US 2024/0246801 A1
(43) Pub. Date: Jul. 25, 2024

(54) Working Machine

(71) Applicant: J. C. Bamford Excavators Limited, Uttoxeter (GB)

(72) Inventor: Richard Howells, Uttoxeter (GB)

(73) Assignee: J. C. Bamford Excavators Limited, Uttoxeter (GB)

(21) Appl. No.: 18/419,540

(22) Filed: Jan. 22, 2024

(30) Foreign Application Priority Data
Jan. 23, 2023 (GB) 2300952.5

(51) Int. Cl. B66F 17/00; B66F 9/065; B66F 9/075

(52) U.S. Cl. CPC B66F 17/003; B66F 9/0655; B66F 9/0755

(57) ABSTRACT

A working machine includes a body, and a pivotable telescopic working arm having an implement at its distal end. The machine includes a collision avoidance system having a control system to determine a height of the working implement at the distal end of the working arm and to define a first zone having an area below the working implement, a first sensor mounted on the working machine and configured to monitor the area defined by the first zone to generate a sensor output signal, and a display configured to display the sensor output. The control system is configured so that the area defined by the first zone is based on the height of the working implement to determine if an animate object is located within the first zone, and to provide an operator alert if it is determined that an animate object is in the first zone.

### FIELD

The present teachings relate to a working machine.

### BACKGROUND

Off-highway vehicles or working machines are for example those used in construction industries configured to transport loads over a surface. One such working machine is a telescopic handler, often referred to as telehandlers or rotating telehandlers, that are typically used to lift, move, lower, and place material or cargo. These working machines typically have a working arm pivotally mounted to the body of the machine, and a working implement, such as a bucket, forks, or a grabber, attached to the end of the arm via a coupling device. Attachment of the working implement enables the working machine to perform a variety of tasks on a work site. Some of these tasks involve moving between, stopping, and moving loads at certain locations within a worksite where workers are present. These workers may be positioned in areas in which a collision may occur between the working machine and the worker and/or between the worker and the load being carried.

The present teachings seek to overcome or at least mitigate one or more problems associated with the prior art.

### SUMMARY

A first aspect of the teachings provides a working machine comprising: a body; a ground engaging propulsion structure supporting the body; a telescopic working arm mounted to the body to be pivotable about a substantially horizontal axis, wherein a working implement is mounted to a distal end of the working arm; and a collision avoidance system comprising, a control system configured to determine a height of the working implement at the distal end of the working arm and to define a first zone having an area below the working implement, at least one first sensor mounted on the working machine and configured to monitor the area defined by the first zone and to generate a sensor output signal, a display configured to display the sensor output from the at least one first sensor, wherein the control system is configured such that the area defined by the first zone is based on the determined height of the working implement at the distal end of the working arm, and wherein the control system is configured to determine if an animate object is located within the first zone and to provide an output for alerting an operator of the working machine if it is determined that an animate object is in the first zone.

The working machine is provided with a control system that is able to identify that a person or animal is located near to the working machine and to provide an output in response to this determination. Thus, the present collision avoidance system helps to reduce the risk of a collision between a working machine and an animate object.

The control system may be configured such that the area defined by the first zone increases as the height of the working implement increases. The control system may be configured such that the area defined by the first zone is proportional to the height of the working implement.

The collision avoidance system may comprise a sensor configured to determine an angle of the working arm relative to the body and the control system is configured to determine the height of the working implement based on the angle of the working arm.

The collision avoidance system may comprise a sensor configured to determine an extension of the working arm and the control system is configured to determine the height of the working implement based on the extension of the working arm.

The collision avoidance system may comprise a sensor configured to determine a position of the working implement relative to the body in three-dimensional space, and wherein the control system is configured such that the size and location of the area of the first zone is based on the position of the working implement relative to the body in three-dimensional space.

The control system may be configured to determine a center of gravity of the working machine, and wherein the control system is configured such that the size and location of the area of the first zone is based on the determined center of gravity of the working machine. The control system may be configured to determine the center of gravity of the working machine based on one or more of: a position of the working implement relative to the body in three-dimensional space; a speed of travel of the working machine; an inclination of the working machine; a load carried by the working implement; a direction of travel of the working machine; and/or a rate of change of speed of the working machine.

The working machine may comprise an inclination sensor configured to determine an inclination of the working machine, wherein the control system may be configured to adjust the location of the area of the first zone relative to the working implement based on the determined inclination of the working machine.

The control system may be configured to adjust the location of the area of the first zone relative to the working implement based on a speed of travel and/or direction of travel of the working machine.

The control system may be configured to adjust the size of the area of the first zone and/or position of the area of the first zone relative to the working implement based on a rate of change of speed of travel of the working machine.

The control system may be configured to adjust the size of the area of the first zone relative to the working implement based on a load carried by the working implement. The control system may be configured such that the size of the area of the first zone is proportional to the load carried by the working implement. The control system may be configured such that the location of the area of the first zone relative to the working implement is proportional to the load carried by the working implement.

The output from the control system may comprise activating an indicator or activating an alarm.

The working machine may comprise an override control such that an output generated in response to an animate object being detected in the first zone is able to be deactivated.

The control system may be configured to track or follow the deactivated animate object within the first zone and not to generate a further output based on this detected animate object when it is in the first zone. The control system may be configured to determine if a deactivated animate object re-enters the first zone and not to generate a further output based on this detected animate object. The control system may be configured not to generate a further output based on the detected animate object when the deactivated animate object re-enters the first zone within a predetermined period of time.

The at least one sensor may be configured to identify an animate object in the first zone, and wherein the control system is configured selectively provide an output for alerting an operator of the working machine based on the identification of the animate object. The at least one sensor may be configured to identify an animate object based on one or more of: an active tag on an animate object; facial recognition; feature recognition; or a gait of the animate object.

The working machine may comprise an operator input and a memory, and wherein, in use, an operator of the working machine can input a failure to detect an animate object and/or an incorrect determination of an animate object in the first zone so as to be stored on the memory.

The body may comprise an undercarriage and a superstructure rotatably mounted on the undercarriage, and wherein the working arm is mounted on the superstructure.

The control system may be configured to restrict operation of the working machine if it is determined that an animate object has been detected in the first zone. The control system may be configured to restrict operation of the working machine by one or more of: providing a rate of gradual stop of the working machine; preventing raising of the working implement; preventing further extension of the working arm; limiting a rate of change of speed of the working machine; limiting a speed of travel of the working machine; and/or limiting or preventing a change of direction of the working machine.

The at least one first sensor may comprise a plurality of cameras mounted on the body of the working machine and configured to monitor an area in its field of view and to generate a camera output signal to the display. The control system may be configured to define a plurality of second zones, to assign the outputs of the plurality of cameras to the plurality of second zones, and wherein the control system is configured to provide an output for alerting an operator if it is determined that an animate object has been detected in at least one second zone. The control system may be configured to display the first zone and/or one or more of the second zones on the display. The control system may be configured to divide the camera outputs into a plurality of second zones independently of the mounted positions of the cameras and to assign the camera outputs to said zones.

When an animate object is detected in a second zone and is determined to be at a greater distance from the working machine than a predetermined threshold distance, the control system may be configured to provide a first, or low, risk warning, and when an animate object is detected within a second zone and is determined to be within a predetermined distance from the working machine, the control system is configured to provide a second, or high, risk waring. When it is determined that an animate object has been detected in at least two of the first zone and the plurality of second zones, the control system may be configured to assign a collision risk level to each detected animate object and to prioritize the zone or zones to display on the display based on the assigned collision risk levels.

The control system may be configured to prioritize the zone to display based on one or more of: a position of the detected animate object relative to a direction of travel of the working machine; a proximity of the detected animate object to the working machine; a most recently detected animate object; a determined center of gravity of the working machine; and/or a number of animate objects detected in each danger zone.

The control system may be configured to assign a first, or highest, level of priority to zone based on a position of the detected animate object relative to a direction of travel of the working machine and/or a determined potential tipping direction of the working machine. The direction of travel of the working machine may be based on a selected state of a forward/neutral/reverse (FNR) drive selector; and/or an angular position of a steering wheel. The determined potential tipping direction of the working machine may be based on a determined center of gravity of the machine.

The control system may be configured to assign a second level of priority, below the first level of priority, based on a proximity of the detected animate objects to the working machine.

When more than one of the plurality of cameras detect animate objects within a predetermined distance from the working machine, the control system may be configured to prioritize the camera output signal to display based on the highest number of animate objects detected within said predetermined distance.

The control system may be configured to assign a third level of priority, below the second level of priority, based on a most recent detection of an animate object. The control system may be configured to assign a fourth level of priority, below the third level of priority, based on a total number of animate objects detected in a zone.

The control system may be configured to provide a warning, alert, or notification on the display in relation to a detected animate object not displayed on the display.

The display may be configured to operate in a plurality of display modes comprising a zone display mode in which the display is configured to display a zone and at least one other display mode, wherein, when it is determined that an animate object has been detected in a zone the control system is configured to override the selection of the at least one other display mode to display the zone in which the animate object has been detected.

The control system may be configured to determine whether a detected object is an animate object to determine whether an animate object is within the zone.

The control system may comprise a processor configured to execute a machine learning algorithm trained to determine whether the detected object is an animate object to determine whether an animate object is within the zone.

The machine learning algorithm may be able to reliably determine whether or not an object in the field of view of the one or more cameras is an animate objection. Hence, the use of the machine learning algorithm to determine whether or not an object in a camera's field of view helps to improve the reliability of the collision avoidance system.

### BRIEF DESCRIPTION OF THE DRAWINGS

Embodiments will now be described with reference to the accompanying drawings, in which:

FIG. 1 is a schematic side view of a working machine;

FIG. 2 is a schematic plan view of the working machine of FIG. 1 according to an embodiment;

FIG. 3 is a schematic side view of the working machine of FIG. 1;

FIG. 4 is a schematic side view of the working machine of FIG. 1;

FIG. 5 is a schematic plan view of the working machine of FIG. 1 according to an embodiment;

FIG. 6 is a schematic plan view of the working machine of FIG. 1 illustrating the field of view of the cameras; and

FIG. 7 is schematic plan view of the working machine of FIG. 1 illustrating the operational zones of the working machine.

### DETAILED DESCRIPTION OF EMBODIMENT(S)

In the following detailed description, numerous specific details are set forth in order to provide a thorough understanding of various embodiments and the inventive concept. However, those skilled in the art will understand that: the present invention may be practiced without these specific details or with known equivalents of these specific details; that the present invention is not limited to the described embodiments; and, that the present invention may be practiced in a variety of alternative embodiments. It will also be appreciated that well known methods, procedures, components, and systems may not have been described in detail.

References to vertical and horizontal in the present disclosure should be understood to be in relation to the machine when stood on horizontal ground in a non-working condition. The term axial is generally used in relation to the longitudinal axis of the machine. The term width is generally used in relation to the longitudinal length, that is, transverse to the length.

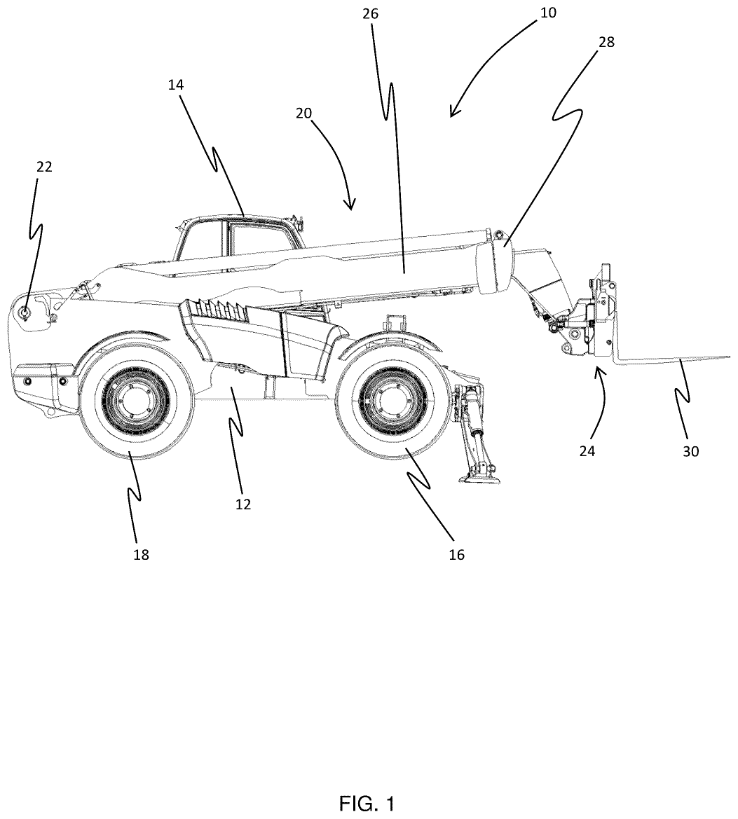

Referring firstly to FIG. 1, an embodiment of the teachings includes a working machine 10. The working machine may be a load handling machine. In this embodiment, the load handling machine 10 is a telescopic handler. In other embodiments the load handling machine 10 may be a rotating telescopic handler, a forklift, an excavator, a skid-steer loader, a compact track loader, a wheel loader, or a telescopic wheel loader, a tractor, for example. Such working machines may be denoted as off-highway vehicles or as non-road mobile machinery. The working machine 10 includes a machine body 12. The machine body 12 may include, for example, an operator's cab 14 from which an operator can operate the machine 10. The operator cab 14 may be mounted on the body 12 so as to be offset from a center of the body. Although in alternative arrangements, the cab 14 may be substantially central.

The working machine 10 has a ground engaging propulsion structure or arrangement. The ground engaging propulsion arrangement or structure supports the body 12. A working arm 20 is pivotally connected to the body 12. Put another way, the working arm 20 is mounted to the body 12 so as to be pivotable about a substantially horizontal axis. The working arm 20 is connected to the body 12 by a mount 22 proximate a first end, or proximal end, of the working arm 20.

The body 12 may include an undercarriage or chassis including the ground engaging propulsion arrangement, and a superstructure. The superstructure may include the cab and arm. In some arrangements, the superstructure may be rotatable (e.g. about a substantially vertical axis) relative to the undercarriage/chassis. Put another way, the superstructure may be rotatable relative to the ground engaging propulsion structure. It will be appreciated that the mount 22 may be provided on the undercarriage/chassis or the superstructure.

The ground engaging propulsion structure includes a first, or front, axle and a second, or rear, axle, each axle being coupled to a pair of wheels 16, 18. In other embodiments, the ground engaging propulsion structure may include a pair of endless tracks. One or both of the axles may be coupled to a drive arrangement (not shown) configured to drive movement of the ground engaging propulsion structure (i.e. the axles). The drive arrangement causes movement of the working machine 10 over a ground surface. The drive arrangement includes a primer mover and a transmission. The prime mover may be an internal combustion engine, an electric motor, or may be a hybrid comprising both an internal combustion engine, an electric motor.

In the present embodiment, the working arm 20 is a telescopic working arm. The telescopic arm includes a first section 26 connected to the mount 22 and a second section 28 which is telescopically fitted to the first section 26. In this embodiment, the second section 28 of the working arm 20 is telescopically moveable with respect to the first section 26 such that the working arm 20 can be extended and retracted. Movement of the second section 28 with respect to the first section 26 of the working arm 20 may be achieved by use of an extension actuator (not shown), for example a double acting hydraulic linear actuator, an electric linear actuator, a telescopic extension ram, multiple extension rams, and/or a chain and pulley system. As will be appreciated, the working arm 20 may include a plurality of sections, for example two, three, four or more sections. Each arm section may be telescopically fitted to at least one other section, and an actuator may be provided therebetween. In alternative arrangements, the working arm 20 may not be telescopic and may include a first am pivotally mounted to the mount 22. In such arrangements, the working arm 20 may also include a second arm pivotally mounted to the first arm.

The working arm 20 can be moved with respect to the machine body 12 and the movement is preferably, at least in part, rotational movement about the mount 22. The rotational movement is about a substantially transverse axis of the machine 10 (i.e. about a horizontal axis). Rotational movement of the working arm 20 with respect to the machine body 12 is, in an embodiment, achieved by use of at least one lifting actuator (not shown) coupled between the arm 20 and the body 12.

A working implement 30 is mounted to a distal end of the working arm 20. In the arrangement shown, a carriage assembly 24 is mounted to a second, or distal, end 21 of the working arm 20 and a working implement, e.g. a load handling implement, 30 is mounted to the carriage assembly 24. In some arrangements, the carriage or carriage assembly 24 may be omitted. The working machine 10 is configured to transport loads over uneven ground, i.e. with a load held by the working implement 30, an operator controls the ground engaging propulsion structure to move the machine 10 with the load from one location to another. In the illustrated arrangement, the working implement is a pair of forks 30, e.g. a pair of laterally spaced apart forks. The forks 30 project forwardly from the carriage assembly 24. In alternative arrangements, the working implement may be a bucket, or a basket etc., or any other suitable working implement.

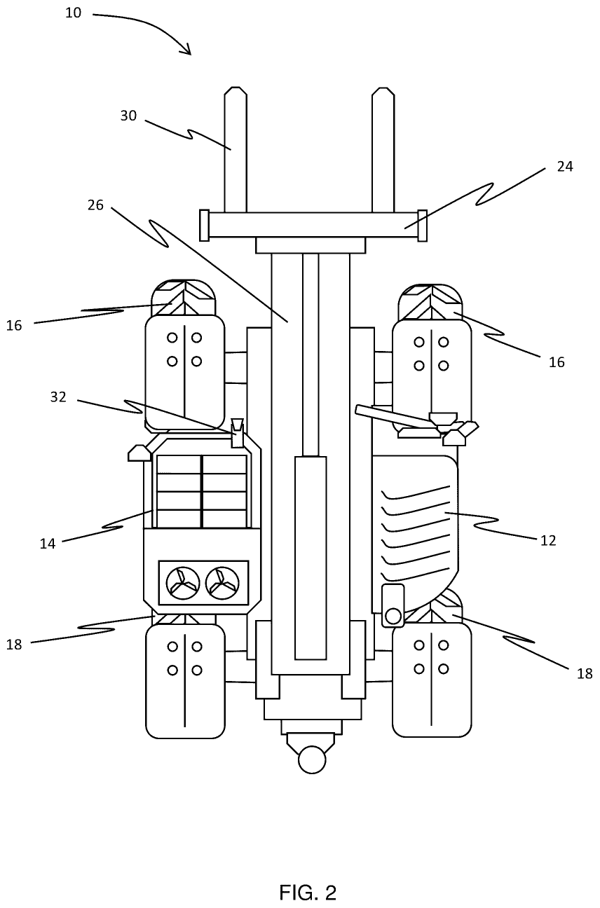

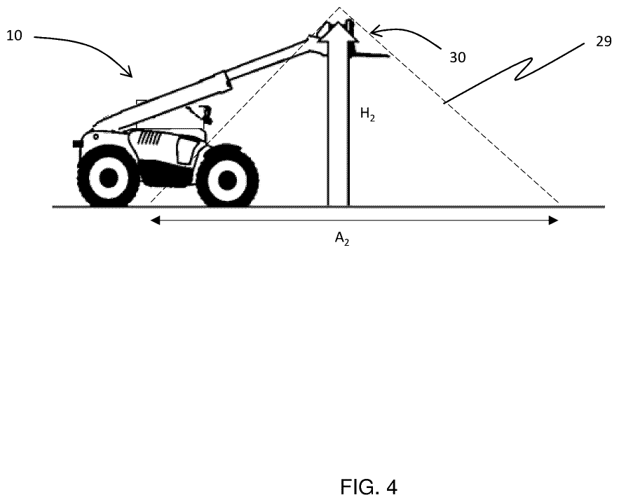

Referring now to FIGS. 2 to 4, the working machine 10 includes a collision avoidance system. For working machines such as telehandlers and rotating telehandlers, people or workers should not be within a danger ‘tipping zone’ or fall zone of the machine to prevent a collision in the event the working machine 10 falls over.

This danger zone, tipping zone, or fall zone may be referred to as a first zone 29. The collision avoidance system includes a control system. The control system is configured to determine a height H of the working implement 30 at the distal end of the working arm 20 and to define the first zone 29 having an area A below the working implement 30. The area includes, but is not limited to, the area directly beneath the working implement 30. The first zone 29 is intended to encompass an area in which it is reasonably foreseeable that a load carried by the working machine 10 could fall and/or the machine could fall over and cause an accidental collision with a pedestrian in the first area. The control system is configured to determine whether a detected object is an animate object to determine whether an animate object is within the zone.

The collision avoidance system includes at least one first sensor 32 mounted on the working machine 10. The at least one first sensor 32 is configured to monitor the area A defined by the first zone 29 and to generate a sensor output signal. The collision avoidance system is also provided with a display. The display may be a touch screen display such that the display can be operated as an operator input. The display may be positioned within the operator cab 14. The display is configured to display the sensor output from the at least one first sensor 32. The control system is configured such that the area A defined by the first zone 29 is based on the determined height H of the working implement 30 at the distal end of the working arm 20. The control system is configured to determine if an animate object is located within the area defined by the first zone 29 and to provide an output for alerting an operator of the working machine 10 if it is determined that an animate object is in the first zone 29. The output from the control system may be an audio and/or visual output, for example the output may include activating an indicator and/or activating an alarm.

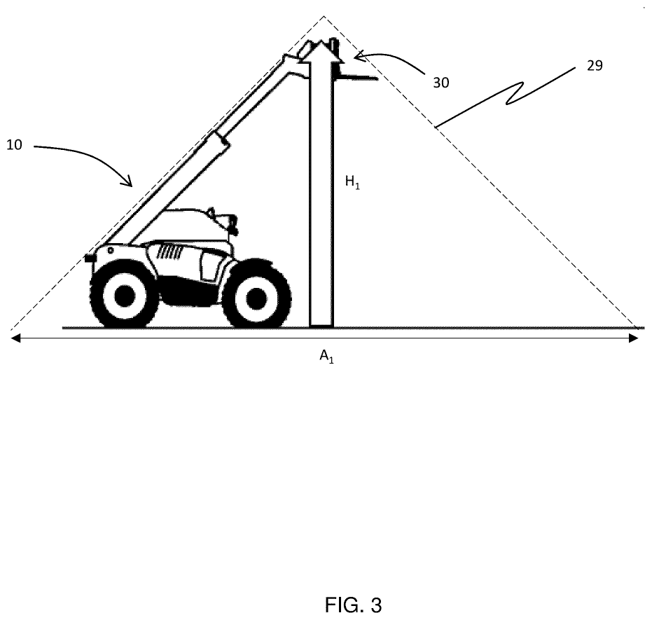

The control system may be configured such that the area A defined by the first zone 29 increases as the height H of the working implement 30 increases. A first area A1 is defined by the first zone 29 for a first height H1 (illustrated in FIG. 3), and a second area A2, smaller than the first area A1, is defined by the first zone 29 for a second height H2 that is less than the first height H1. The area A defined by the first zone 29 is proportional to the height H of the working implement 30. In some arrangements, the first zone 29 may extend away from the working machine 10 by a distance that is equal to the height H of the boom (i.e. the working implement 30) in case the working machine 10 falls over.

The control system may be configured such that a location of the area A of the first zone 29 relative to the working implement 30 and/or body 12 is based on a determined inclination of the working machine 10. In such arrangements, the working machine 10 may be provided with an inclination sensor configured to determine an inclination of the working machine 10.

Alternatively or additionally, the control system may be configured to adjust the location of the area A of the first zone 29 relative to the working implement 30 or body 12 and/or to adjust the size of the area of the first zone 29 based on one or more of: a speed of travel; a direction of travel of the working machine 10; and/or a rate of change of speed of travel of the working machine 10. The direction of travel of the working machine 10 may be based on a selected state of a forward/neutral/reverse (FNR) drive selector; and/or an angular position of a steering wheel.

In some arrangements, the control system may be configured to adjust the size of the area A of the first zone 29 based on a load carried by the working implement 30. In such arrangements, the size of the area A of the first zone 29 is proportional to the load carried by the working implement 30. It will be appreciated that the location of the area A of the first zone 29 relative to the working implement may also be dependent on the load carried by the working implement 30.

The collision avoidance system may include a sensor configured to determine an angle of the working arm 20 relative to the body 12. It will be appreciated that the first sensor 32 may be configured to determine the angle of the working arm 20 relative to the body 12. In such arrangements, the first camera may be a camera or other sensor that is capable of detecting both a height of the working implement 30 and the angle of the arm. In other arrangements, a further sensor may be provided to determine the angle of the arm, such as a further camera or a sensor to detect a position of an actuator controlling pivoting of the working arm 20, or any other suitable sensing arrangement. The control system may be configured to determine the height H of the working implement 30 based on the angle of the working arm 20.

The collision avoidance system may include a sensor configured to determine an extension of the working arm 20. It will be appreciated that the first sensor 32 may be configured to determine the extension of the working arm 20. In such arrangements, the first camera may be a camera or other sensor that is capable of detecting both a height H of the working implement 30 and the extension of the arm 20. In other arrangements, a further sensor may be provided to determine the extension of the arm, such as a further camera or a sensor to detect a position of an actuator controlling extension of the working arm 20, or any other suitable sensing arrangement. The control system may be configured to determine the height H of the working implement 30 based on the extension of the working arm 20.

In some arrangements, the collision avoidance system may include a sensor configured to determine a position of the working implement 30 relative to the body 12 in three-dimensional space. In such arrangements, the control system may be configured such that the size and location of the area A of the first zone 29 is based on the position of the working implement 30 relative to the body in three-dimensional space. In some embodiments, the control system may be configured to determine a center of gravity of the working machine 10 such that the size and location of the area A of the first zone 29 is based on the determined center of gravity of the working machine 10. The determined potential tipping direction of the working machine 10 may be based on a determined center of gravity of the machine 10. In such arrangements, the control system may be configured to determine the center of gravity of the working machine 10 based on one or more of: a position of the working implement 30 relative to the body in three-dimensional space; a speed of travel of the working machine 10; an inclination of the working machine 10; a load carried by the working implement 30; a direction of travel of the working machine 10; and/or a rate of change of speed of the working machine 10.

In some arrangements, the control system can be overridden via an override control to deactivate an output, alert, or indicator generated in response to an animate object being detected in the first zone 29. In this arrangement, the first sensor 32 may be configured to track or follow the deactivated animate object within the first zone 29 and to not generate a further output based on this detected animate object. It will be appreciated that the override control may be operated via the touchscreen display, or via a separate display, switch, or control. In some arrangements, the control system may be configured to determine if a deactivated animate object re-enters the first zone 29 and not to generate a further output based on this detected animate object. The control system may not generate a further output based on the detected animate object when the deactivated animate object re-enters the first zone 29 within a predetermined period of time.

The control system and/or the first sensor 32 may be configured to identify an animate object in the first zone 29, and to selectively provide an output for alerting an operator of the working machine 10 based on the identification of the animate object. Identification of the animate object may be based on one or more of: an active tag on an animate object; facial recognition; feature recognition; or a gait of the animate object.

The working machine may include an operator input (e.g. via a touchscreen input on the display). The control system may include a memory (not shown). An operator may be able to input a failure to detect an animate object and/or an incorrect determination of an animate object into the control system via the operator input so as to be stored on the memory.

The control system may be configured to restrict operation of the working machine 10 if it is determined that an animate object has been detected in the first zone 29. Restricting operation of the working machine 10 may include one or more of: providing a rate of gradual stop of the working machine 10; preventing raising of the working implement 30; preventing further extension of the working arm 20; limiting a rate of change of speed of the working machine 10; limiting a speed of travel of the working machine 10; and/or limiting or preventing a change of direction of the working machine 10.

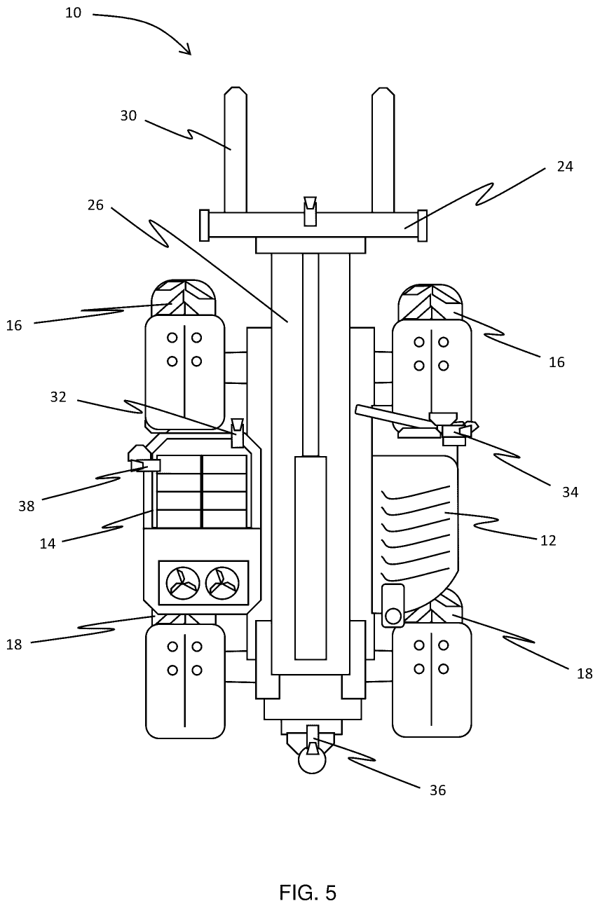

Referring now to FIG. 5, the collision avoidance system may also include at least one second sensor. The or each second sensor may be a camera. In the arrangement shown, the collision avoidance system includes a plurality of cameras mounted on the body 12 of the working machine. The working machine 10 has four cameras mounted to the body 12. A first camera 32 is mounted at or near to a front of the working machine 10. A second camera 34 is mounted at or near a first side, e.g. a right side, of the working machine 10. The first side of the working machine 10 is a side of the working machine 10 that is remote from the operator cab 14. A third camera 36 is mounted at or near to a rear of the working machine 10. A fourth camera 38 is mounted at or near a second, e.g. left, side of the working machine 10. The second side of the working machine 10 is a side of the working machine 10 that is proximate to the operator cab 14. Although the working machine 10 has been illustrated with four cameras 32, 34, 36, 38, it will be appreciated that any suitable number of cameras may be used. In the present embodiment, the first sensor 32 is the same as the first camera 32. However, in alternative arrangements separate sensors/cameras may be provided.

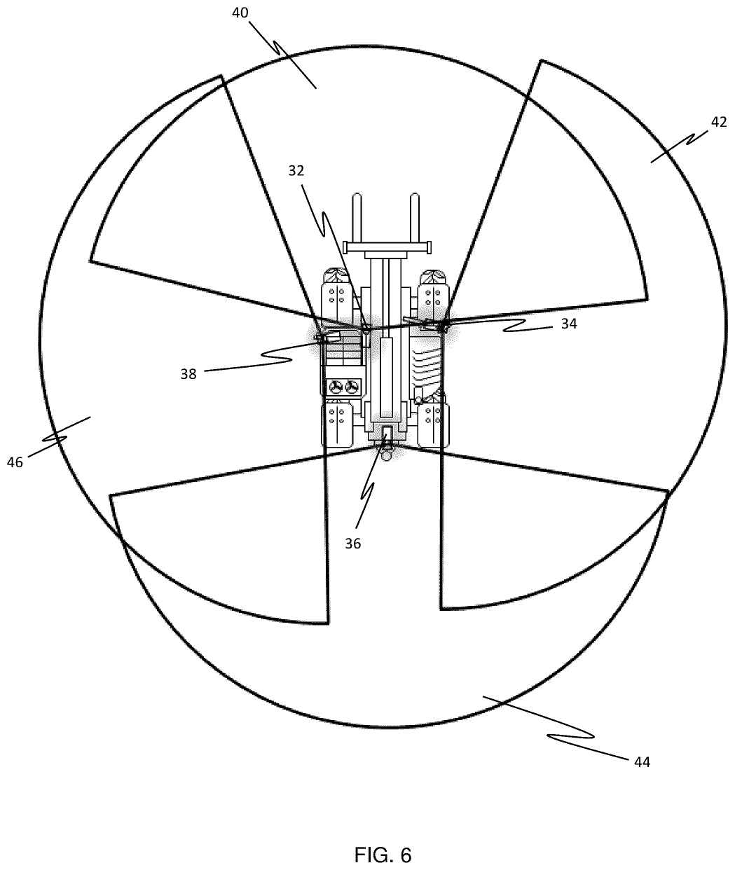

Referring now to FIG. 6, each camera 32, 34, 36, 38 is configured to monitor an area in its respective field of view 40, 42, 44, 46. The one or more cameras 32, 34, 36, 38 may be arranged and configured so as to provide a 360° field of view around the working machine 10. Each camera 32, 34, 36, 38 relays the images of the monitored areas in the form of a camera output signal to the control system to be displayed on the display. The camera output signals from the plurality of cameras 32, 34, 36, 38 are sent to the control system over a single stream. The control system is configured to generate an output signal for alerting an operator if it is determined that an animate object has been detected in the field of view of the at least one camera 32, 34, 36, 38. The output from the control system comprises activating an indicator, activating an alarm, and/or displaying one or more camera output signal on a display.

The display is configured to display the camera outputs from the plurality of cameras 32, 34, 36, 38, and the control system may be configured to divide the camera outputs into a plurality of second zones, as is discussed in more detail below. The control system may be configured to assign the camera outputs to said second zones, and to display at least one second zone on the display. It will be appreciated that the display may display the first zone 29 and/or one or more of the plurality of second zones. The plurality of second zones may be positioned around the body 12 of the working machine.

It will be appreciated that the cameras 32, 34, 36, 38 may be mounted on the undercarriage or chassis of the working machine 10. In such arrangements, the fields of view 40, 42, 44, 46 of the cameras 32, 34, 36, 38 may be fixed relative to the undercarriage or chassis (e.g. in the event that that a superstructure is rotated relative to the undercarriage/chassis. It will also be appreciated that the cameras 32, 34, 36, 38 may be mounted on a superstructure (e.g. a rotatable superstructure). In these arrangements, the control system may be configured to enable an operator to select whether the fields of view 40, 42, 44, 46 of the cameras 32, 34, 36, 38 remains fixed relative to the undercarriage/chassis or remains fixed relative to the superstructure (i.e. fixed relative to the operator cab 14). It will be appreciated that the control system may be configured such that the displayed first zone may be configured to select, e.g. via an operator input such as the touchscreen display, whether displayed first zone remains fixed relative to the undercarriage or remain fixed relative to the superstructure. In arrangements where the control system is configured to divide the camera outputs into a plurality of second zones, the control system may be configured to select, e.g. via an operator input such as the touchscreen display, whether displayed second zones remain fixed relative to the undercarriage or remain fixed relative to the superstructure.

The control system may be configured to restrict or inhibit movement of the working machine 10 in a direction towards a detected animate object, in response to a detected animate object in said field of view. It will be understood that the animate objects may be a pedestrian/person or an animal. The control system may be configured to prevent a change in a direction to travel of the working machine 10 and/or to apply brakes (not shown) to restrict or inhibit movement of the working machine 10 in a direction towards a detected animate object, in response to a detected animate object in said field of view. It will be appreciated that the control system is configured to restrict or inhibit movement of the working machine 10 in a direction towards a detected animate object whether the cameras 32, 34, 36, 38 are mounted on the undercarriage/chassis or a superstructure.

Restricting or inhibiting movement of the working machine 10 in a direction towards a detected animate object may be provided in the form of providing a gradual stop of the working machine 10, if it is determined that an animate object has been detected in the field of view of at least one camera 32, 34, 36, 38. The rate of the gradual stop may be based on one or more of: proximity of the detected animate object; the load carried by the working arm; vehicle speed; direction of travel of the working machine; and/or the position of the working arm. It will be appreciated that the direction of travel of the working machine 10 may be based on a selected state of a forward/neutral/reverse (FNR) drive selector (not shown), an angular position of a steering wheel (not shown), an angular orientation of the wheels, or any other suitable means.

The one or more cameras may also include a camera configured and arranged to monitor a field of view above the operator cab 14. The control system may be configured to define a zone corresponding to the area above the operator cab 14. The one or more cameras may also include cameras to provide an operator with a view below the body of the working machine 10, and/or to provide a view of the rear end of the working machine 10, e.g. to provide improved visibility of a tow hitch or a three-point hitch (not shown). In arrangements where the body includes a chassis having front and rear chassis that are pivotable relative to each other, the one or more cameras may include a camera to monitor the area between the front and rear chassis. It will be appreciated that each of the front and rear chassis will be provided with a ground engaging propulsion structure. It will be appreciated that the control system may be configured to define a zone corresponding to one or more of these areas relative to the working machine.

The control system is configured to provide an output if it is determined that an animate object has been detected in the field of view of at least one camera 32, 34, 36, 38. The control system may be configured to provide an output for alerting an operator if it is determined that an animate object has been detected at least one second zone. The output may be an override of one or more functions of the working machine 10. The output may be an alert to alert to alert an operator of the working machine 10. The alert may be an audio and or visual alert.

The control system may be configured to communicate that an animate object has been detected in the field of view of at least one camera 32, 34, 36, 38 to an indicator. The working machine may include an array of indicators, e.g. lights of speakers, within an operator cab 14. The control system may indicate a position of a detected animate object relative to the cab 14 via the array of indicators (not shown). For example, the cab 14 may include forward, right side, rear and left side indicators, and the control system may activate the indicator corresponding to the side/region of the working machine 10 in which an animate object has been detected. In arrangements where the control system is configured to divide the camera outputs into a plurality of second zones, the indicators are arranged within the operator cab 14 such that an indicator is positioned within the cab proximate to each second zone.

When an animate object is detected in a zone and/or by a camera the control system may be configured to provide a first, or low, risk warning, and a second, or high, risk waring. The high and low risk warning may be alarms of different pitch or frequency (with higher pitch and/or frequency corresponding to a higher risk level). The high and low risk warnings may be provided in the form of different colored indicators, with a red indicator corresponding to a high risk level and an amber indicator corresponding to a low risk level.

The high risk level and low risk level may be based on a distance of a detected animate object away from the working machine 10. For example, when a detected animate object is determined to be at a greater distance from the working machine than a predetermined threshold distance, the control system may be configured to provide a first, or low, risk warning, and when an animate object is detected within a second zone and is determined to be within a predetermined distance from the working machine, the control system may be configured to provide a second, or high, risk waring.

When it is determined that an animate object has been detected in the field of view of one or more of the plurality of cameras 32, 34, 36, 38, the control system is configured to select a camera output signal from one or more cameras to display on a display. If an animate object is only detected by one of the cameras 32, 34, 36, 38, then the camera output from that camera is displayed on the display. When it is determined that an animate object has been detected in at least two zones, the control system is configured to assign a collision risk level to each detected animate object and to prioritize the zone or zones to display on the display based on assigned collision risk levels.

The display may be configured to operate in a plurality of display modes. The display modes may include a camera display mode in which the display is configured to display a camera output from one or more of the plurality of cameras 32, 34, 36, 38 (i.e. to display the first zone and plurality of second zones) and at least one other display mode. When it is determined that an animate object has been detected in the field of view of at least one camera 32, 34, 36, 38, the control system may be configured to override the selection of the at least one other display mode to activate the camera display mode. When the control system is configured to divide the camera outputs into a plurality of second zones and to assign the camera outputs to said zones, the control system may be configured to override the selection of the at least one other display mode to activate the camera display mode to display at least one zone on the display.

If an animate object is detected by more than one camera 32, 34, 36, 38, i.e. at least two cameras, the control system is configured to select the camera output to display based on one or more of: the direction of movement of the working machine; the proximity of the animate objects detected by the cameras; a determined center of gravity of the working machine; the most recently detected animate object; and/or the number of animated objects detected by each camera. 16. The control system may be configured to provide a warning, alert, or notification on the display in relation to a detected animate object not displayed on the display. The notification may be provided in the form of an arrow, a flashing light, or any other suitable means.

In some arrangements, when an animate object is detected by more than one camera 32, 34, 36, 38, i.e. at least two cameras, and/or in more than one zone, the control system may be configured to prioritize the camera output signal or signals from the at least two cameras 32, 34, 36, 38 to select a camera output signal (or a zone) to display on the display. The control system may be configured to prioritize the camera output signal from the at least two cameras 32, 34, 36, 38 based on one or more of: a position of the detected animate object relative to a direction of travel of the working machine 10; a proximity of the detected animate object to the working machine 10; a determined center of gravity of the working machine; a most recently detected animate object; and/or a number of animate objects detected by each camera 32, 34, 36, 38.

In some arrangements, the control system may be configured to assign a first, or highest, level of priority based on a position of the detected animate object relative to a direction of travel of the working machine 10 and/or a determined potential tipping direction of the working machine. It will be appreciated that the direction of travel of the working machine 10 may be based on a selected state of a forward/neutral/reverse (FNR) drive selector (not shown), an angular position of a steering wheel (not shown), an angular orientation of the wheels, or any other suitable means. The FNR drive selector engages drive in a selected direction, or selects a neutral gear. The drive selector is configured to be operated by an operator of the working machine 10 to indicate an intended driving direction of the working machine 10, i.e. forward or reverse. The drive selector 50 may be located within the operator cab 14.

The control system may be configured to assign a second level of priority, below the first level of priority, based on a proximity of the detected animate objects to the working machine 10. When more than one of the plurality of cameras 32, 34, 36, 38 detect animate objects within a predetermined distance from the working machine 10, the control system may be configured to prioritize the camera output signal to display on the display based on the highest number of animate objects detected within said predetermined distance.

The control system may be configured to assign a third level of priority, below the second level of priority, based on a most recent detection of an animate object. The control system may be configured to assign a fourth level of priority, below the third level of priority, based on a total number of animate objects detected by each camera 32, 34, 36, 38.

It will be appreciated that the above prioritization levels may be changed by an operator. In some arrangements, this prioritization order may be changed via an operator input on the working machine, for example via the display. In alternative arrangements, this prioritization order may be changed by connecting a removable storage device, for example a USB interface to which a portable hard disk or memory stick may be connected, to a socket of the working machine, to transfer new prioritizations to the control system.

The control system may be configured to stitch the images from the plurality of cameras 32, 34, 36, 38 together to provide a 360° visual representation on the display. If one or more animate objects are detected by two or more adjacent cameras 32, 34, 36, 38, the control system may stitch the outputs from the cameras together and to display the output together on the display.

The field of views of the plurality of cameras provide a combined field of view greater than 360°. Put another way, the field of view of adjacent cameras 32, 34, 36, 38 overlap. This arrangement enables the cameras to maintain a full 360° field of view when one or more of the cameras 32, 34, 36, 38 a knocked/moved (i.e. when one or more of the cameras is moved out of alignment). In the illustrated arrangement, the four cameras 32, 34, 36, 38 each have a field of view of 170° degrees.

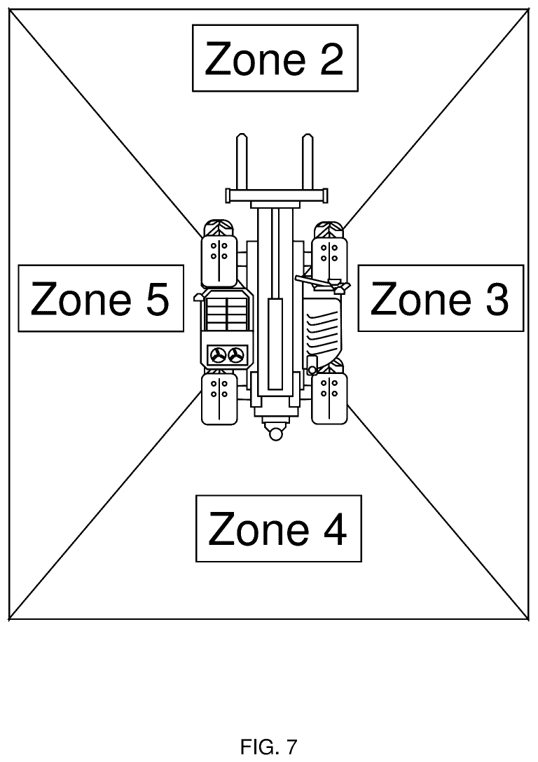

Referring now to FIG. 7, the camera outputs from the one or more cameras 32, 34, 36, 38 may be divided up into four zones. It will be appreciated that any suitable number of zones may be defined. A first zone 48 is at the front of the working machine 10. A second zone 50 is at a first, e.g. right, side of the working machine 10. The first side of the working machine 10 is a side of the working machine 10 that is remote from the operator cab 14. A third zone 52 is at the rear of the working machine 10. A fourth zone 54 is at a second, e.g. left, side of the working machine 10. The second side of the working machine 10 is a side of the working machine 10 that is proximate to the operator cab 14. In the illustrated arrangement, the four zones 48, 50, 52, 54 correspond to the fields of view 40, 42, 44, 46 of each of the cameras 32, 34, 36, 38. However, it will be appreciated that the plurality of second zones are defined independently of the mounted positions of the cameras 32, 34, 36, 38.

The zones corresponding to the front, first and second sides and rear may be defined with respect to the undercarriage or superstructure, optionally, via an operator input (such as the touchscreen display).

One or more of the cameras can be deactivated by an operator of the working machine 10 via the control system. The operator of the working machine 10 has an unobstructed view in the fourth zone 54 due to the position of the cab 14. In some arrangements, only the camera(s) or zone(s) monitoring a side of the working machine 10 proximate to the operator cab 14 can be deactivated. Put another way, in some arrangements, only the camera or cameras monitoring the fourth zone 54 can be deactivated. In such arrangements, the working machine 10 may include a first override control such that one or more of the plurality of cameras can be deactivated by an operator of the working machine 10 via the control system. It will be appreciated that the first override control may be operated via the touchscreen display, or via a separate display, switch, or control. This arrangement can be advantageous when the working machine 10 is being operated with the assistance of a banksman, as it prevents the control system from preventing or inhibiting movement of the working machine 10 due to the presence of a banksman in this area/zone. In some arrangements, the control system can be overridden via a second override to deactivate an alert generated in response to an animate object being detected in the field of view of one or more of the cameras. In this arrangement, the camera (i.e. the monitored zone would remain active) but the control system is configured to track or follow the deactivated animate object within the zone and to not generate an output based on this detected animate object. It will be appreciated that the second override control may be operated via the touchscreen display, or via a separate display, switch, or control.

In some arrangements, the control system may include a processor configured to execute a machine learning algorithm trained to determine whether the detected animate object is an animate object to determine whether an animate object is within the field of view of at least one camera 32, 34, 36, 38 from the camera output signal(s). The control system is configured to provide an output to alert an operator of the working machine 10 if it is determined by the machine learning algorithm that an animate object has been detected in the field of view of at least one camera 32, 34, 36, 38. The control system is configured to provide an output to the display and/or indicators 60, or to an alarm or other device, to alert an operator of the working machine 10 if it is determined that an animate object has been detected in the field of view of at least one camera 32, 34, 36, 38. The control system may also be configured to transmit information relation to the detection of a animate object by one or more of the cameras to a remote location via a transmitter 62. In some arrangements, the control system may be configured to predict a trajectory of movement of a detected animate object and to determine whether or not a collision is likely to occur based on this determination. In alternative arrangements, it will be appreciated that the machine learning algorithm may be omitted, and the control system may be configured to determine whether an objected detected by one or more of the at least one cameras is an animate object, and to generate an output as has been discussed above.

The working machine may include an operator input (e.g. via a touchscreen input on the display). The control system may include a memory (not shown). An operator may be able to input a failure to detect an animate object and/or an incorrect determination of an animate object by the machine learning algorithm into the control system via the operator input so as to be stored on the memory. This input from the operator may be used to improve the training of the algorithm on a remote electronic device. Subsequent to this, an improved machine learning algorithm may then be loaded onto the memory of the control device.

The machine learning algorithm comprises a neural network. The neural network system includes the processor which receives output signals from the cameras 32, 34, 36, 38. The processor executes a neural network process, shown in more detail in FIG. 6. The neural network is capable of performing pattern recognition, and the neural network is able to determine whether the detected animate object is an animate object based on this pattern recognition.

FIG. 6 illustrates the neural network process 64 which is carried out by the processor in the neutral network system 58. An output signal is generated by one or more of the cameras 32, 34, 36, 38 when an object is detected by one or more of the cameras 32, 34, 36, 38 at step 66. At step 68, the camera output signal(s) is received and processed by a neural network that has previously been trained to determine whether or not a animate object is within the field of view of one or more of the cameras 32, 34, 36, 38 from output signals from said cameras 32, 34, 36, 38. The neural network determines whether or not a animate object is within the field of view of one or more the cameras 32, 34, 36, 38 at step 70. The neural network outputs the detection of an animate object at step 72 and, at step 74, whether or not an animate object has been detected by one or more of the cameras 32, 34, 36, 38 is communicated to an output device (such as a display/indicator/alarm 60, the memory (not shown), and/or transmitted to a further device at a remote location).

It is desirable to train the neural network over a wide range of different working environments, and to perform the animate object detection under a wide range of different conditions. It will be understood that the training of the neural network includes training in a range of different locations and weather conditions and temperatures.

The one or more embodiments are described above by way of example only and it will be appreciated that the variations are possible without departing from the scope of protection afforded by the appended claims.

1. A working machine comprising:
a body;
a ground engaging propulsion structure supporting the body;
a telescopic working arm mounted to the body to be pivotable about a substantially horizontal axis, wherein a working implement is mounted to a distal end of the working arm; and
a collision avoidance system comprising,
a control system configured to determine a height of the working implement at the distal end of the working arm and to define a first zone having an area below the working implement,
at least one first sensor mounted on the working machine and configured to monitor the area defined by the first zone and to generate a sensor output signal,
a display configured to display the sensor output from the at least one first sensor,
wherein the control system is configured such that the area defined by the first zone is based on the determined height of the working implement at the distal end of the working arm, and
wherein the control system is configured to determine if an animate object is located within the first zone and to provide an output for alerting an operator of the working machine if it is determined that an animate object is in the first zone.

2. The working machine according to claim 1, wherein the control system is configured such that the area defined by the first zone increases as the height of the working implement increases, optionally wherein the control system is configured such that the area defined by the first zone is proportional to the height of the working implement.

3. The working machine according to claim 1, wherein the collision avoidance system comprises a sensor configured to determine an angle of the working arm relative to the body and the control system is configured to determine the height of the working implement based on the angle of the working arm and/or wherein the collision avoidance system comprises a sensor configured to determine an extension of the working arm and the control system is configured to determine the height of the working implement based on the extension of the working arm.

4. The working machine according to claim 1, wherein the collision avoidance system comprises a sensor configured to determine a position of the working implement relative to the body in three-dimensional space, and wherein the control system is configured such that the size and location of the area of the first zone is based on the position of the working implement relative to the body in three-dimensional space.

5. The working machine according to claim 1, wherein the control system is configured to determine a center of gravity of the working machine, and wherein the control system is configured such that the size and location of the area of the first zone is based on the determined center of gravity of the working machine.

6. The working machine according to claim 1, comprising an inclination sensor configured to determine an inclination of the working machine, wherein the control system is configured to adjust the location of the area of the first zone relative to the working implement based on the determined inclination of the working machine.

7. The working machine according to claim 1, wherein the control system is configured to adjust the location of the area of the first zone relative to the working implement based on a speed of travel and/or direction of travel of the working machine.

8. The working machine according to claim 1, wherein the control system is configured to adjust the size of the area of the first zone and/or position of the area of the first zone relative to the working implement based on a rate of change of speed of travel of the working machine.

9. The working machine according to claim 1, wherein the control system is configured to adjust the size of the area of the first zone relative to the working implement based on a load carried by the working implement, optionally wherein the control system is configured such that the size of the area of the first zone is proportional to the load carried by the working implement.

10. The working machine according to claim 1, comprising an override control such that an output generated in response to an animate object being detected in the first zone is able to be deactivated.

11. The working machine according to claim 1, wherein the at least one sensor is configured to identify an animate object in the first zone, and wherein the control system is configured selectively provide an output for alerting an operator of the working machine based on the identification of the animate object, optionally wherein the at least one sensor is configured to identify an animate object based on one or more of: an active tag on an animate object; facial recognition; feature recognition; or a gait of the animate object.

12. The working machine according to claim 1, wherein the control system is configured to restrict operation of the working machine if it is determined that an animate object has been detected in the first zone.

13. The working machine according to claim 12, wherein the control system is configured to restrict operation of the working machine by one or more of: providing a rate of gradual stop of the working machine; preventing raising of the working implement; preventing further extension of the working arm; limiting a rate of change of speed of the working machine; limiting a speed of travel of the working machine; and/or limiting or preventing a change of direction of the working machine.

14. The working machine according to claim 1, wherein the at least one first sensor comprises a plurality of cameras mounted on the body of the working machine and configured to monitor an area in its field of view and to generate a camera output signal to the display.

15. The working machine according to claim 14, wherein the control system is configured to define a plurality of second zones, to assign the outputs of the plurality of cameras to the plurality of second zones, and wherein the control system is configured to provide an output for alerting an operator if it is determined that an animate object has been detected in at least one second zone, optionally wherein the control system is configured to display the first zone and/or one or more of the second zones on the display.

16. The working machine according to claim 15, wherein, when an animate object is detected in a second zone and is determined to be at a greater distance from the working machine than a predetermined threshold distance, the control system is configured to provide a first, or low, risk warning, and when an animate object is detected within a second zone and is determined to be within a predetermined distance from the working machine, the control system is configured to provide a second, or high, risk waring.

17. The working machine according to claim 15, wherein, when it is determined that an animate object has been detected in at least two of the first zone and the plurality of second zones, the control system is configured to assign a collision risk level to each detected animate object and to prioritize the zone or zones to display on the display based on the assigned collision risk levels.

18. The working machine according to claim 17, wherein the control system is configured to prioritize the zone to display based on one or more of: a position of the detected animate object relative to a direction of travel of the working machine; a proximity of the detected animate object to the working machine; a most recently detected animate object; a determined center of gravity of the working machine; and/or a number of animate objects detected in each danger zone.

19. The working machine according to claim 17, wherein, when more than one of the plurality of cameras detect animate objects within a predetermined distance from the working machine, the control system is configured to prioritize the camera output signal to display based on the highest number of animate objects detected within said predetermined distance.

20. The working machine according to claim 1, wherein the display is configured to operate in a plurality of display modes comprising a zone display mode in which the display is configured to display a zone and at least one other display mode, wherein, when it is determined that an animate object has been detected in a zone the control system is configured to override the selection of the at least one other display mode to display the zone in which the animate object has been detected.
